(19) United States
(12) Patent Application Publication
(10) Pub. No.: US 2002/0174265 A1
(43) Pub. Date: Nov. 21, 2002

(54) Method and apparatus for caching active computing environments

(76) Inventor: Brian K. Schmidt, Mountain View, CA (US)

Correspondence Address: BRIAN M. BERLINER, ESQ., O'MELVENY & MYERS LLP, 400 SOUTH HOPE STREET, LOS ANGELES, CA, 90071-2899, US

(21) Appl. No.: 09/822,156

(22) Filed: Mar. 28, 2001

(51) Int. Cl. G06F 9/00

(52) U.S. Cl. 709/328; 709/315; 709/102

(57) ABSTRACT

The present invention is for the caching of active computing environments. According to one or more embodiments of the present invention a compute capsule (or capsule) is provided. A capsule encapsulates an active computing environment. An active computing environment comprises one or more processes and the complete state necessary for the execution of those processes. To provide this encapsulation, an interface between component modules of the operating system is provided. In one embodiment, this interface has two complementary actions: export state and import state. When the export state action is invoked for a particular resource object, the appropriate module responds with all the internal kernel state associated with the object. Conversely, when the import state action is invoked with the state information provided by an export state action, it recreates the exact state of the resource object. Thus, the present invention records the full and complete state of a set of processes (in a capsule) and caches both the state and the processes. This, inturn, provides the ability to move capsules to a new machine or to suspended them in stable storage, and then restore them to the running state as if there had been no disruption.

### BACKGROUND OF THE INVENTION

1. Field of the Invention

The present invention relates to caching active computing environments.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

In modern computing it is desirable for a user to be interacting with a computer, to stop the interaction with the computer, to move to a new computer, and to begin interacting with the new computer at precisely the point where the user stopped interacting with the first computer. Using current schemes, however, this is not possible because the user's computing environment cannot be represented in a form that can be understood by both computers and moved between the computers.

However, in co-pending U.S. patent application entitled “Method and Apparatus for Representing and Encapsulating Active Computing Environments” application No. 09/764,771 filed on Jan. 16, 2001, assigned to the assignee of the present application, and hereby fully incorporated into the present application by reference, it was described how a group of active processes and their associated state could be represented and encapsulated. In addition, in co-pending U.S. patent application entitled “Method and Apparatus for Virtual Namespaces for Active Computing Environments” application No. 09/765,879 filed on Jan. 18, 2001, assigned to the assignee of the present application, and hereby fully incorporated into the present application by reference, it was described how the encapsulation of the active computing environment and the resources used by the environment could be achieved in a manner that is independent of any particular host machine.

Given this backdrop it is desirable to use the complete, host-independent encapsulation of the active computing environment, as a cacheable entity and use the encapsulation the way data is used in a cache. Using current schemes, however, this is not possible. Before further discussing the drawbacks of current schemes, it is instructive to discuss how the nature of computing is changing.

The Nature of Computing

The nature of computing is changing. Until recently, modern computing was mostly “machine-centric”, where a user accessed a dedicated computer at a single location. The dedicated computer had all the data and computer programs necessary for the user to operate the computer, and ideally, it had large amounts of hardware, such as disk drives, memory, processors, and the like. With the advent of computer networks, however, different computers have become more desirable and the focus of computing has become “service-oriented”. In particular, computer networks allow a user to access data and computer programs that exist elsewhere in the network. When the user accesses such data or computer programs, the remote computer is said to be providing a service to the user. With the improvement in services available to users, the need to have a dedicated computer following the machine-centric paradigm is greatly reduced. The machine-centric paradigm also becomes much less practical in this environment because distributing services is much more cost-effective.

In particular, desktop computers in a service-oriented environment have little need for powerful hardware. For instance, the remote computer processes the instructions before providing the service, so a powerful processor is not needed on the local access hardware. Similarly, since the service is providing the data, there is little need to have large capacity disk drives on the local access hardware. In such an environment, one advantage is that computer systems have been implemented that allow a user to access any computer in the system and still use the computer in the same manner (i.e., have access to the same data and computer programs).

For instance, a user may be in location A and running a word processor, a web browser, and an interactive multimedia simulation. In a service-oriented environment, the user might stop using the computer in location A and move to location B where the user could resume these computer programs on a different machine at the exact point where the user stopped using the machine at location A, as long as both computers had access via the computer network to the servers where the programs were being executed. The programs in this example, however, cannot be moved between computers when they are active because of the design of current operating systems.

Caching

Access time and capacity of different memory technologies used in computer systems are inversely related (e.g., large capacity memory such as disk drives are much slower at retrieving data than standard dynamic random access memory (DRAM). At the same time slower memory technologies are less costly than high-speed technologies. To achieve access times that are on par with expensive high-speed memory while supporting a large capacity, less costly memory system, caching is typically used in modern computing systems. A cache is a small, high-speed memory system that contains a subset of the data stored in a larger, slower memory system.

A cache is used to increase the performance of a computing system Data in the cache may be used by the computing system much faster because the cache lets the computer avoid a slow and costly access of memory or disk to acquire the data. A typical cache operates under the assumption that recently used data is likely to be re-used in the future, so it is beneficial to leave that data there for later use. Caches typically store data and retrieve the data when it is needed for a computation or for another reason. One caching scheme determines a capacity for the data and evicts data from the cache when the capacity is reached. Various eviction schemes are used including evicting the entry that has been unused for the longest time, for instance. Caches may also be used for persistence, for instance when an object is evicted it maybe written to disk.

Similarly, the processor for a computer and the operating system can be viewed as a cache containing active computations. For instance, the processor stores the intermediate results of a computation and uses the results to further perform computations. These computations, however, cannot be moved outside that particular processor. Regardless of the caching scheme, there is no scheme where an active computing environment is used as a cacheable entity.

### SUMMARY OF THE INVENTION

The present invention is for the caching of active computing environments. According to one or more embodiments of the present invention a compute capsule is provided. The compute capsule maybe halted, moved to a different machine having potentially a different operating system, cached on the new machine, and re-started using the cache when the user desires to begin operating the new machine.

In one embodiment, to cache an active computing environment, an interface between component modules of the operating system is provided. This interface has two complementary actions: export state and import state. When the export state action is invoked for a particular resource object, the appropriate module responds with all the internal kernel state associated with the object. Conversely, when the import state action is invoked with the state information provided by an export state action, it recreates the exact state of the resource object.

Using the export state/import state functionality, the present invention records the full and complete state of a set of processes (in a capsule) and caches both the state and the processes. This, in turn, provides the ability to move capsules to a new machine with a different operating system or to suspend them in stable storage, and then restore them to the running state as if there had been no disruption. In one embodiment, two new operations are defined: a capsule_checkpoint operation halts an active computing environment, and a capsule_restart call resumes the execution of the capsule (potentially after it has been moved to a new location). In another embodiment, when a capsule is moved to a new machine, it is treated like any other cacheable entity, namely, it is determined whether the cache is full and if it is, the environment is either suspended in stable storage or other environments are evicted from the cache to make room for it.

### BRIEF DESCRIPTION OF THE DRAWINGS

These and other features, aspects and advantages of the present invention will become better understood with regard to the following description, appended claims and accompanying drawings where:

FIG. 1 is a block diagram showing the re-partitioning of the ownership between the operating system and the compute capsule according to one embodiment of the present invention.

FIG. 2 is a flowchart of the export state action according to an embodiment of the present invention.

FIG. 3 is a flowchart of the import state action according to an embodiment of the present invention.

FIG. 4 shows a capsule_checkpoint operation according to an embodiment of the present invention.

FIG. 5 shows a capsule_checkpoint operation according to another embodiment of the present invention.

FIG. 6 shows a capsule_restart operation according to an embodiment of the present invention.

FIG. 7 shows a capsule_restart operation according to another embodiment of the present invention.

FIG. 8 shows one example of the appearance of a re-started active computing environment.

FIG. 9 illustrates capsule relocation according to an embodiment of the present invention.

FIG. 10 shows the caching of an active computing environment according to an embodiment of the present invention.

FIG. 11 is an embodiment of a computer execution environment in which one or more embodiments of the present invention can be implemented.

### DETAILED DESCRIPTION OF THE INVENTION

The invention is for caching active computing environments. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Compute Capsules

A compute capsule comprises one or more processes and their associated system environment. A compute capsule is configured to provide an encapsulated form that is capable of being moved between computers or stored off-line, for instance on a disk drive or other non-volatile storage medium. The system environment in a capsule comprises state information relating to exactly what the processes are doing at any given time in a form that is understandable by any binary compatible machine. System environment information may include, for instance, privileges, configuration settings, working directories and files, assigned resources, open devices, installed software, and internal program state.

Processes in the same capsule may communicate with each other and share data via standard IPC mechanisms, for instance using pipes, shared memory, or signals. Communication with processes outside the capsule, on the other hand, is restricted to Internet sockets and globally shared files. This ensures that capsules can move without restriction. For example, a pipe between processes in different capsules would force both capsules to reside on the same machine, but a socket can be redirected. The use of compute capsules is completely transparent, and applications need not take any special measures, such as source code modification, re-compilation, or linking with special libraries. In addition, a system using compute capsules can seamlessly inter-operate with systems that do not.

Re-Partitioning the Operating System

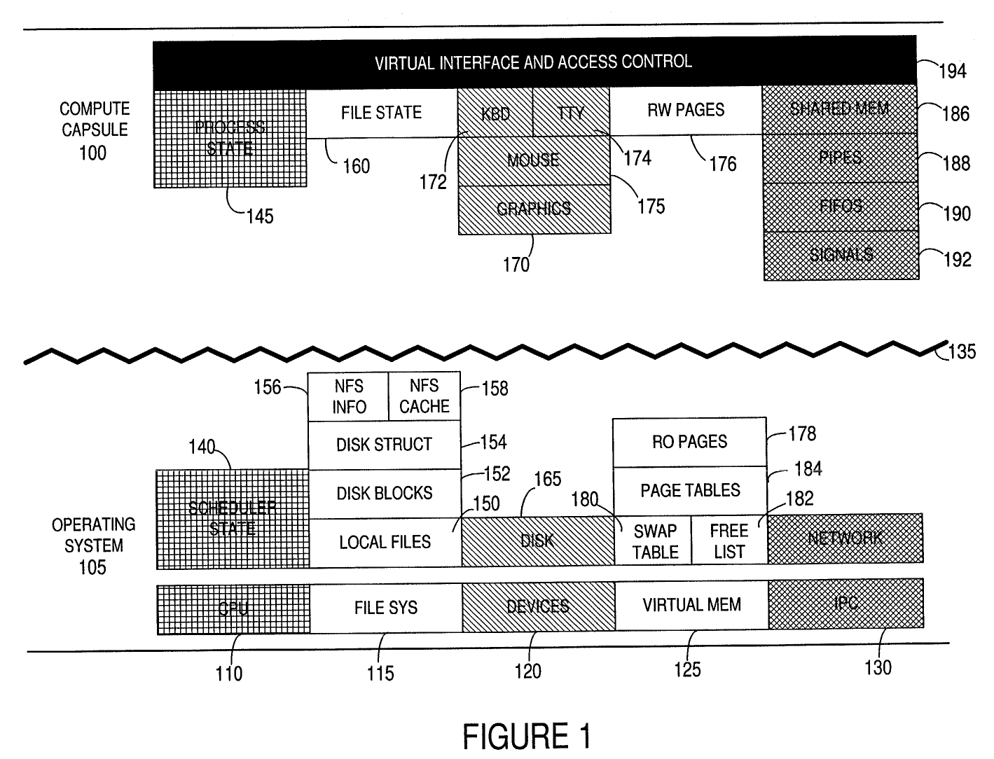

To provide such functionality, the traditional operating system is re-partitioned as shown in FIG. 1 so that all host-dependant and personalized elements of the computing environment are moved into the capsule 100, while leveraging policies and management of the shared underlying system 105. The computing environment comprises CPU 110, file system 115, devices 120, virtual memory 125, and IPC 130. Each of these components of the computing environment have been partitioned as indicated by the curved line 135.

The state of the CPU scheduler 140 is left in the operating system 105. This state comprises information that the operating system maintains so that it knows which processes may run, where they are, what priority they have, how much time they will be granted processor attention, etc. Process state 145, which is moved to the compute capsule 100, has process-specific information, such as the values in the registers, the signal handlers registered, parent/child relationships, access rights, and file tables. The file system 115 leaves local files 150 that are identically available on all machines, (e.g., /usr/bin or /man on a UNIX system) in the operating system 105. The file system 115 further leaves disk blocks 152 outside the capsule, which are caches of disk blocks that are read into the system and can be later used when needed to be read again. The disk structure 154 is also left outside the capsule. The disk structure is specific to an operating system and serves as a cache of where files are located on the disk, (i.e., a mapping of path names to file locations). Network file system (NFS) is a protocol for accessing files on remote systems. The operating system maintains information 156 with respect to the NFS and a cache 158, which is a cache of files the operating system has retrieved from remote servers and stored locally. Similar state is maintained for other network based file systems.

What has been partitioned away from the operating system is the file state 160. The file state 160 is moved to the capsule 100. The file state 160 is the state of a file that some process in the capsule has opened. File state 160 includes, for instance, the name of the file and where the process is currently accessing the file. If the file is not accessible via the network (e.g., stored on a local disk), then its contents are placed in the capsule.

Devices 120 are components that are attached to the computer. For each device there is a driver that maintains the state of the device. The disk state 165 remains in the operating system 105. The other device components are specific to a log-in session and are moved to the capsule 100. The other devices include a graphics controller state 170, which is the content that is being displayed on the screen, for instance the contents of a frame buffer that holds color values for each pixel on a display device, such as a monitor.

Keyboard state 172 and mouse state 175 includes the state associated with the user's current interaction with the keyboard, for instance whether caps lock is on or off and with the screen, for instance where the pointer is currently located. Tty state 174 includes information associated with the terminals the user is accessing, for instance if a user opens an Xwindow on a UNIX system or if a user telnets or performs an rlogin. Tty state 174 also includes information about what the cursor looks like, what types of fonts are displayed in the terminals, and what filters should be applied to make the text appear a certain way, for instance.

Virtual memory 125 has state associated with it. The capsule tracks the state associated with changes made from within the capsule which are termed read/write pages 176. Read-only pages 178 remain outside the capsule. However, in one embodiment read-only pages 178 are moved to the capsule as well, which is useful in some scenarios. For instance, certain commands one would expect to find on a new machine when their capsule migrates there may not be available. Take, for instance, a command such as ls or more on a UNIX system. Those read-only pages may not be necessary to bring into the capsule when it is migrating between UNIX machines, because those pages exist on every UNIX machine. If, however, a user is moving to a machine that does not use those commands, it is useful to move those read only pages into the capsule as well. The swap table 180, which records what virtual memory pages have been replaced and moved to disk, remains outside the capsule as do the free list 182, (which is a list of empty virtual memory pages), and the page table 184.

Nearly all IPC 130 is moved into the capsule. This includes shared memory 186, which comprises a portion of memory that multiple processes maybe using, pipes 188, fifos 190, signals 192, including handler lists and the state needed to know what handler the process was using and to find the handler. The virtual interface and access control list 194 are useful for separating the capsule from host-dependent information that is specific to a machine, such as the structure of internal program state or the IDs for its resources. The interface 194 refers generally to the virtualized naming of resources and translations between virtual resource names and physical resources, as well as lists that control access to processes trying to access capsules.

Thus, capsule state includes data that are host-specific, cached on the local machine to which the capsule is bound, or not otherwise globally accessible. This includes the following information:

Capsule State: Name translation tables, access control list, owner ID, capsule name, etc.;

Processes: Tree structure, process control block, machine context, thread contexts, scheduling parameters, etc.;

Address Space Contents: Read/write pages of virtal memory, because they are available in the file system, contents of read-only files mapped into the address space (e.g., the application binary and libraries) are not included unless explicitly requested;

Open File State: Only file names, permissions, offsets, etc. are required for objects available in the global file system. However, the contents of personal files in local storage (e.g., /tmp) must be included. Because the pathname of a file is discarded after it is opened, for each process one embodiment of the invention maintains a hash table that maps file descriptors to their corresponding pathnames. In addition, some open files have no pathname, (i.e., if an unlink operation has been performed). The contents of such files are included in the capsule as well;

IPC Channels: IPC state has been problematic in most prior systems. The present invention adds a new interface to the kernel modules for each form of IPC. This interface includes two complementary elements: export current state, and import state to re-create channel. For example, the pipe/fifo module is modified to export the list of processes attached to a pipe, its current mode, the list of filter modules it employs, file system mount points, and in-flight data. When given this state data, the system can re-establish an identical pipe;

Open Devices: By adding a state import/export interface similar to that used for IPC, the invention supports the most commonly used devices: keyboard, mouse, graphics controller, and pseudo-terminals. The mouse and keyboard have very little state, mostly the location of the cursor and the state of the LEDs (e.g., caps lock). The graphics controller is more complex. The video mode (e.g., resolution and refresh rate) and the contents of the frame buffer must be recorded, along with any color tables or other specialized hardware settings. Supporting migration between machines with different graphics controllers is troublesome, but a standard remote display interface can address that issue. Pseudo-terminal state includes the controlling process, control settings, a list of streams modules that have been pushed onto it, and any unprocessed data.

Capsules do not include shared resources or the state necessary to manage them (e.g., the processor scheduler, page tables), state for kernel optimizations (e.g., disk caches), local file system, physical resources (e.g., the network), etc.

Importing and Exporting State Information

In conventional operating systems, most of the critical state of active processes is maintained within the kernel and is inaccessible to the application. Such state is dispersed among various kernel data structures, and current schemes provide no facility for extracting it, storing it off-line, or re-creating it from an intermediate representation. The present invention adds a new interface to the operating system so that capsules can import and export critical kernel state.

To cache active computing environments, an interface between component modules of the operating system is provided. In one embodiment, this interface has two complementary actions: export state and import state. When the export state action is invoked for a particular resource object, the appropriate module responds with all the internal kernel state associated with the object. Conversely, when the import state action is invoked with the state information provided by an export state action, it recreates the exact state of the resource object.

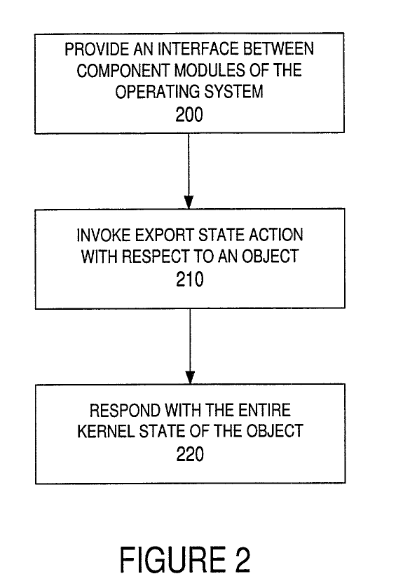

One embodiment of the operation of the export state action is described in FIG. 2. At step 200, an interface between component modules of the operating system is provided. In one embodiment, the operating system is the Solaris operating system. It should be noted, however, that the present invention is configured to work with any operating system that exports a common interface. Next, at step 210, an export state action is invoked with respect to a particular resource object. Then, the module responds with the entire kernel state of the object at step 220.

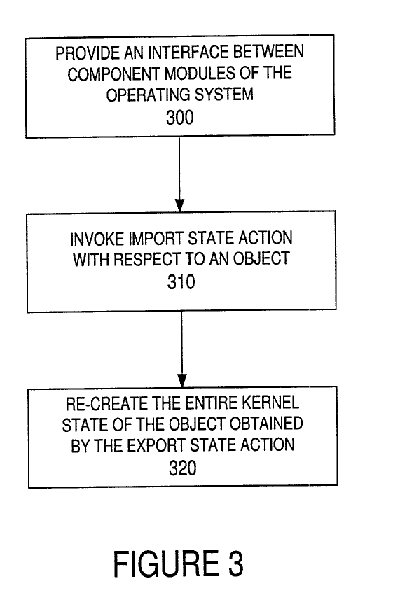

The operation of an embodiment of the import state action is described in FIG. 3. At step 300, an interface between component modules of the operating system is provided. Then at step 310, the import state action is invoked. Thereafter, at step 320, the import state action re-creates the entire kernel state of a resource object obtained from the export state action.

For example, consider a pipe open between a set of processes. The export action would return the list of communicating processes, the filters applied to the data, the status of the user interface, and any in-flight data, for instance. The import action would create a new pipe with identical state. Thus, the present invention records the full and complete state of a set of processes (in a capsule) and caches both the state and the processes. This, in turn, provides the ability to move capsules to a new machine or to suspend them in stable storage, and then restore them to the running state as if there had been no disruption.

Caching Active Computing Environments

In general, caches are implemented under the assumption that it is very likely that some object or piece of data will be repeatedly accessed. Access delays are minimized by keeping popular data close to the entity which needs it. A cache comprises a finite area of a computer's memory and normally contains data. The present invention implements a cache wherein the contents of the cache contain one or more active computing environments

To implement a cache for one or more active computing environments, one embodiment of the invention defines two new operating system interface routines. These new routines are defined in Table 1.

TABLE 1

| Name | Description |
|---|---|
| capsule_checkpoint | Suspend a capsule and record its state. |
| capsule_restart | Restart a capsule from its recorded state. |

Capsule Checkpoint

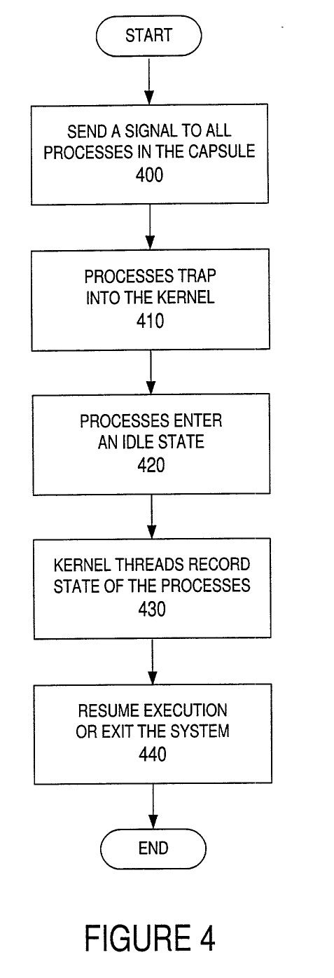

Given the ability to fully obtain the state of a capsule, it is possible to suspend it in persistent storage. One embodiment of the invention implements this functionality with a new system call termed capsule_checkpoint. One embodiment of the capsule_checkpoint operation is shown in FIG. 4. At step 400 the operation traps into the kernel and sends a signal to all processes in the capsule, notifying them that a checkpoint operation is about to take place. Then, the signal forces processes to trap into the kernel (step 410) and enter the idle state (step 420). Once all processes are halted, the capsule state will be totally quiescent, at which point it is safe for kernel threads to record it at step 430 using the state export interface. Then, the capsule resumes execution or exits the system at step 440.

Applications can catch the checkpoint signal and perform whatever actions are desired, but they cannot ignore it, because then the process would not execute the checkpoint operation inside the kernel. In addition, the handler can execute arbitrary code and may never return. Similarly, a process may be executing within the kernel and not notice the signal. Thus, one embodiment adds a time-out on the checkpoint operation to ensure the capsule can resume.

Recording the checkpoint data is primarily an I/O-bound operation, and by far the most costly portion of the checkpoint is writing the address space contents. Therefore, in one embodiment once all other state is recorded, the address spaces of the member processes are duplicated in a copy-on-write mode, and the capsule can proceed with normal execution while the system simultaneously records the address space contents. This procedure is described in further detail below.

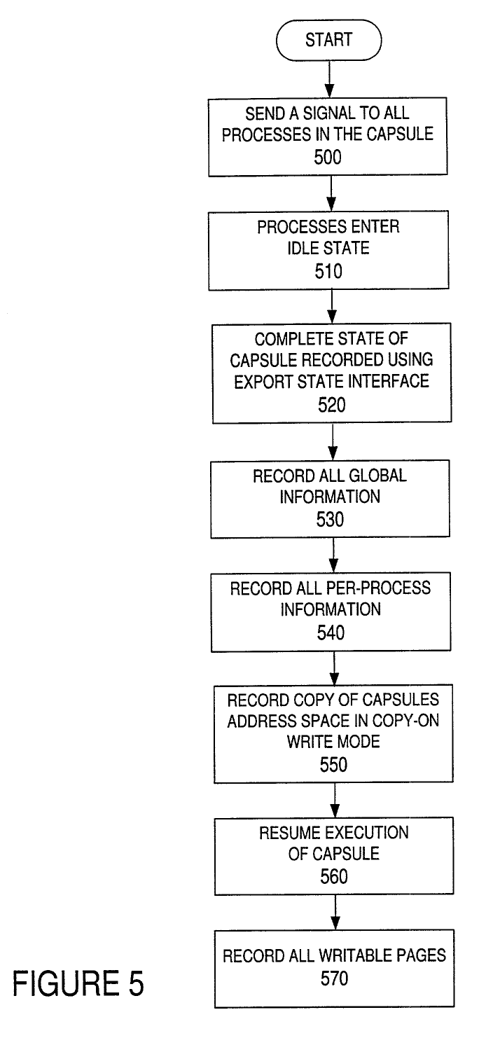

Another embodiment of the capsule_checkpoint operation is shown in FIG. 5. At step 500, the system sends a signal to all processes in the capsule, notifying them that a checkpoint operation is about to take place. Then, the signal forces the processes to enter an idle state (step 510). Once all processes are halted their complete state is recorded at step 520 using the state export interface. Next, all global information is recorded at step 530. Global information includes, for instance, IPC information and the virtized names for resources that the process needs. Next, at step 540, per-process information is recorded. Per-process information includes, for instance, access control lists for the capsule, and files and devices used by the process in the capsule. At step 550, a copy-on write version of the capsule's address space is recorded and at step 560 the capsule is resumed and at step 570, all pages are recorded that may be written.

Capsule Re-Start

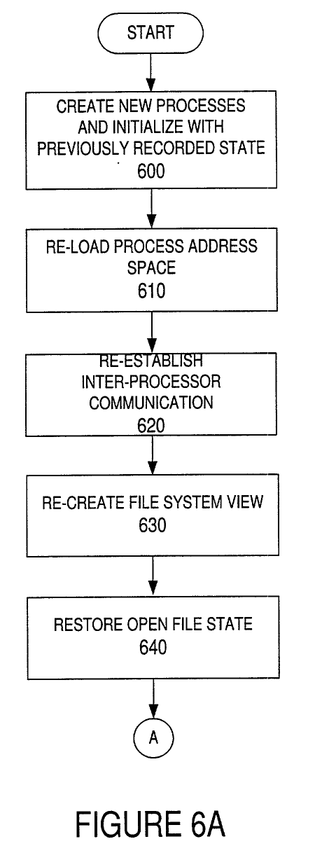

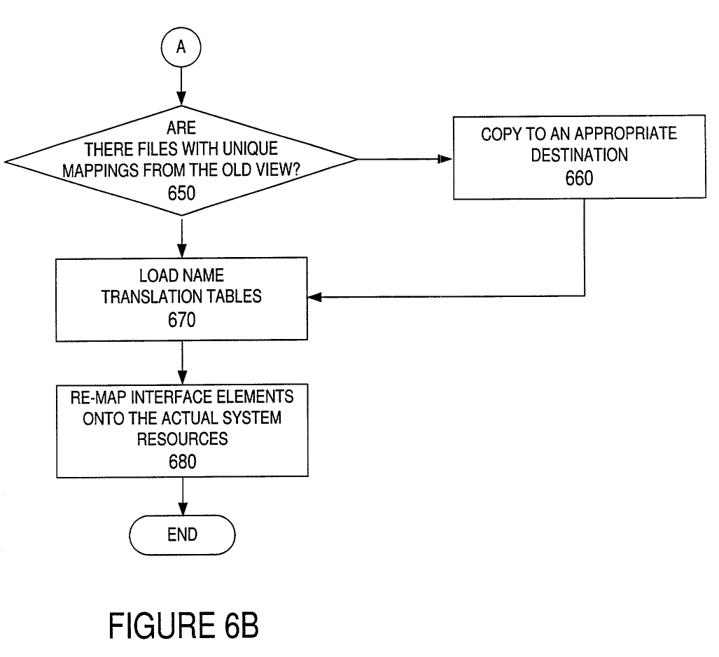

A capsule is relocated by restarting it from its recorded state on a different machine, and this functionality is provided by a new system call termed capsule_restart. One embodiment of the capsule_restart call is shown in FIG. 6. When a process invokes this operation, a trap is made into the kernel, and the system creates a new capsule in which it duplicates the stored state. At step 600, new processes are created and initialized wit the state recorded previously and parent-child relationships are re-created. Process address spaces are re-loaded at step 610, and inter-process communication is re-established at step 620. The file system view is re-created at step 630, and open file state is restored at step 640.

At step 650, it is determined whether there are files with unique mappings from the old view (e.g.,/tmp). If there are not, flow proceeds to step 670. If there are, they are copied to an appropriate new destination at step 660 and flow proceeds to step 670. Translations between the names for resources in the capsule and the actual physical resources are loaded at step 670, and interface elements are re-mapped onto the actual system resources at step 680.

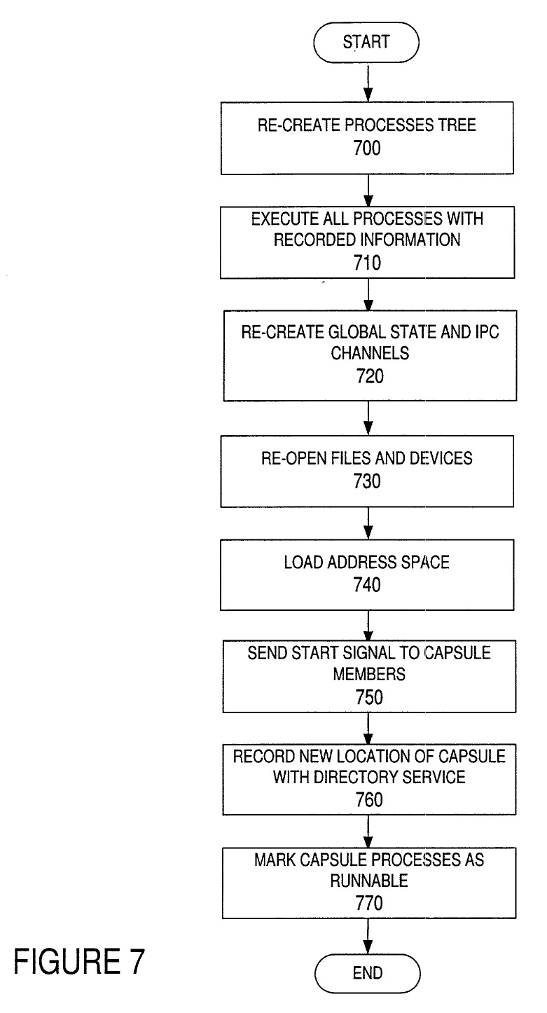

At this point, the capsule state is restored to the conditions at the time of its checkpoint. Another embodiment of the capsule_restart call is shown in FIG. 7. At step 700, the process tree is re-created. At step 710, all processes in the capsule are loaded with recorded information necessary for execution. Then, at step 720, global state and IPC channels are re-created. Next, files and devices are re-opened at step 730. Next, the address space is loaded at step 740 and a start signal is sent at step 750 to capsule members that they are being revived from the suspended state. Thereafter, the new location for the capsule is recorded with a directory service (step 760) and the capsule processes are marked as runnable (step 770).

In one embodiment, before restarting capsule execution, the system places a restart signal at the head of the queue for each process (step 750 above). Thus, when the capsule is resumed, its processes will immediately receive the restart signal so they can perform any desired tasks prior to restarting. Once the restart signal is delivered, all processes are marked runnable, and execution continues as if their had been no interruption. System calls that were executing at the time of the checkpoint will restart automatically or return an error indicating that they should be retried.

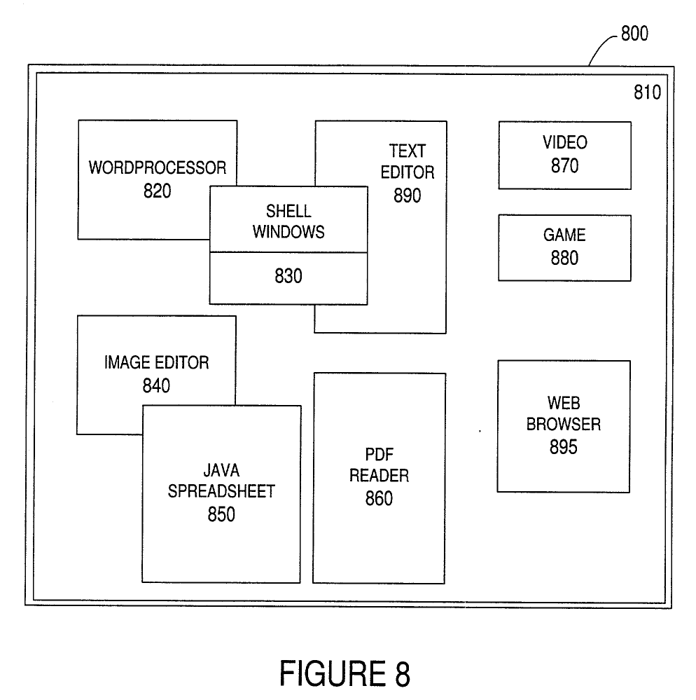

An example of a saved session that has been re-started is shown in FIG. 8. Display 800 may be an output device, such as one or more conventional computer monitors. Display 800 presents active computing environment 810 to the user. Active computing environment 810 comprises seven processes designated as word processor 820, shell terminal window 830, image editor 840, Java spreadsheet 850, PDF reader 860, video 870, game 880, text editor 890, and web browser 895. The screen shot of FIG. 8 is an example of one possible active computing environment, but any group of processes may form a similar computing environment for use with embodiments of the present invention.

Capsule Relocation and Caching

Capsule relocation is provided by the combination of the capsule_checkpoint and capsule_restart system calls. When a user invokes capsule_checkpoint, the system suspends the capsule and records its complete state, which can then be used by to capsule_restart to resume the capsule elsewhere. The name translation tables are persistent within a capsule and are mapped to new machine-local values if the capsule is moved to another host, thereby providing transparent mobility of the computing environment. co-pending U.S. patent application entitled “Method and Apparatus for Representing and Encapsulating Active Computing Environments” application No. 09/764,771 filed on Jan. 16, 2001, assigned to the assignee of the present application, and hereby fully incorporated into the present application by reference, it was described how a group of active processes and their associated state could be represented and encapsulated. Name translation tables are further defined in co-pending U.S. patent application entitled “Method and Apparatus for Virtual Namespaces for Active Computing Environments” application No. 09/765,869 filed on Jan. 18, 2001, assigned to the assignee of the present application, and hereby fully incorporated into the present application by reference.

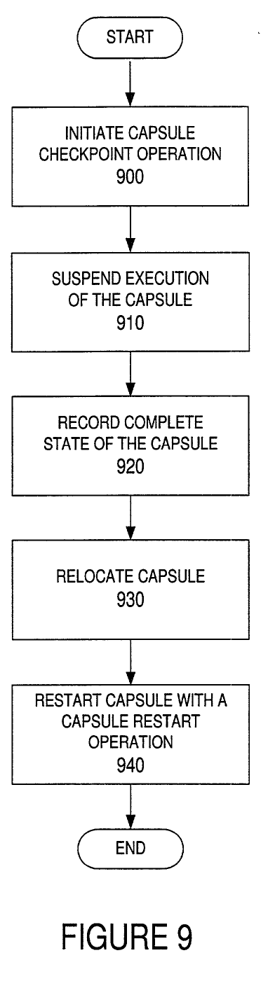

Capsule relocation is described in connection with FIG. 9. At step 900, the user initiates a capsule_checkpoint operation. Next, at step 910, the execution of the capsule is suspended and at step 920 the complete state of the capsule is recorded. Then, the capsule is relocated at step 930. Thereafter, a capsule_restart system call resumes the operation of the capsule at step 940.

In a distributed computing environment, such as a workgroup cluster or the Internet, users cannot move an active computing environment (e.g., a user log-in session) between machines for dynamic load balancing, user mobility, on-line maintenance, and system availability. In addition, users cannot suspend an active computing environment in stable storage to be revived later. The present invention by caching active computing environments enhances system reliability (e.g., checkpoint/re-start a long running computation to survive failures) and scalability (e.g., free resources consumed by idle processes) and provides a way to archive working computing environments for future use (e.g., class instruction, software development, and debugging).

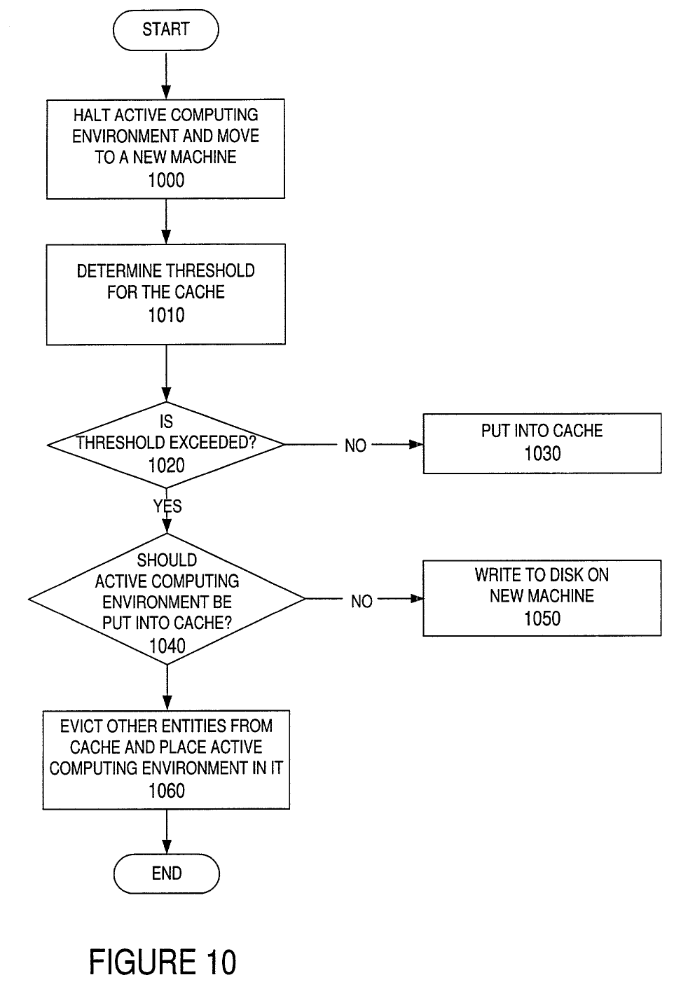

Once moved, the computing environments maybe used similar to a conventional cache for data. For instance, one embodiment of the present invention uses active computing environments as shown in FIG. 10. At step 1000, an active computing environment is halted and moved to a new machine. At step 1010, the new machine determines a threshold for the cache. At step 1020, it is determined if the threshold is exceeded. If not, the active computing environment is put into the cache at step 1030. If the threshold is exceeded, it is determined whether the active computing environment should be put into the cache at step 1040. If not, it is written to disk on the new machine at step 1050. Otherwise, other entities are evicted from the cache and the active computing environment is placed in the cache at step 1060.

Embodiment of Computer Execution Environment (Hardware)

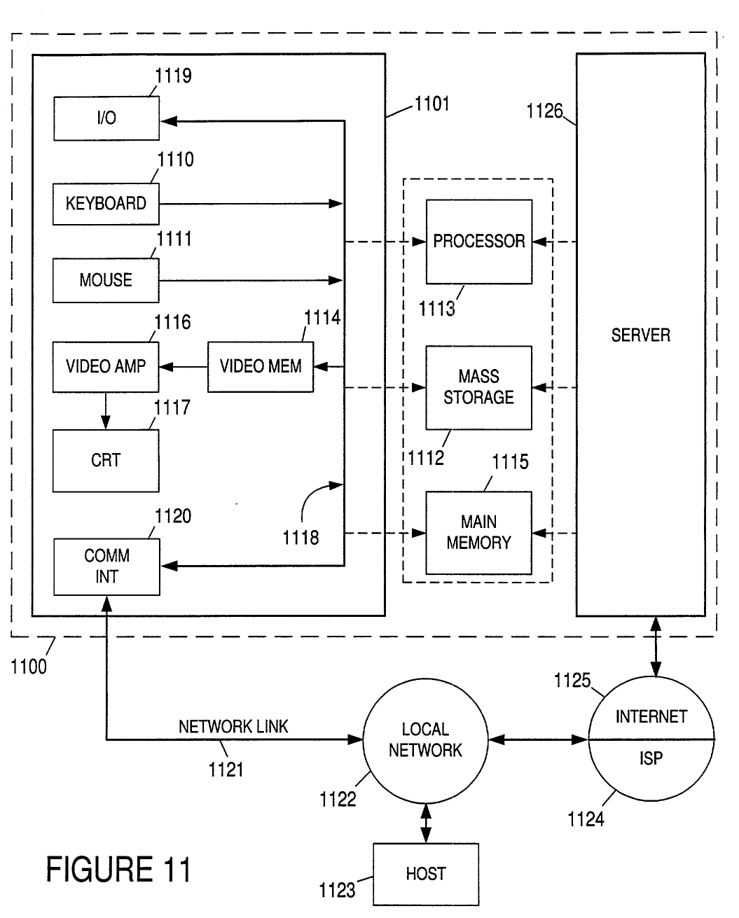

An embodiment of the invention can be implemented as computer software in the form of computer readable program code executed in a general purpose computing environment such as environment 1100 illustrated in FIG. 11, or in the form of byte code class files executable within a Java™ run time environment running in such an environment, or in the form of byte codes running on a processor (or devices enabled to process bytecodes) existing in a distributed environment (e.g., one or more processors on a network). A keyboard 1110 and mouse 1111 are coupled to a system bus 1118. The keyboard and mouse are for introducing user input to the computer system and communicating that user input to central processing unit (CPU) 1113. Other suitable input devices may be used in addition to, or in place of, the mouse 1111 and keyboard 1110. I/O (input/output) unit 1119 coupled to bidirectional system bus 1118 represents such I/O elements as a printer, A/V (audio/video) I/O, etc.

Computer 1101 may include a communication interface 1120 coupled to bus 1118. Communication interface 1120 provides a two-way data communication coupling via a network link 1121 to a local network 1122. For example, if communication interface 1120 is an integrated services digital network (ISDN) card or a modern, communication interface 1120 provides a data communication connection to the corresponding type of telephone line, which comprises part of network link 1121. If communication interface 1120 is a local area network (LAN) card, communication interface 1120 provides a data communication connection via network link 1121 to a compatible LAN. Wireless links are also possible. In any such implementation, communication interface 1120 sends and receives electrical, electromagnetic or optical signals which carry digital data streams representing various types of information.

Network link 1121 typically provides data communication through one or more networks to other data devices. For example, network link 1121 may provide a connection through local network 1122 to local server computer 1123 or to data equipment operated by ISP 1124. ISP 1124 in turn provides data communication services through the world wide packet data communication network now commonly referred to as the “Internet” 1125. Local network 1122 and Internet 1125 both use electrical, electromagnetic or optical signals which carry digital data streams. The signals through the various networks and the signals on network link 1121 and through communication interface 1120, which carry the digital data to and from computer 1100, are exemplary forms of carrer waves transporting the information.

Processor 1113 may reside wholly on client computer 1101 or wholly on server 1126 or processor 1113 may have its computational power distributed between computer 1101 and server 1126. Server 1126 symbolically is represented in FIG. 11 as one unit, but server 1126 can also be distributed between multiple “tiers”. In one embodiment, server 1126 comprises a middle and back tier where application logic executes in the middle tier and persistent data is obtained in the back tier. In the case where processor 1113 resides wholly on server 1126, the results of the computations performed by processor 1113 are transmitted to computer 1101 via Internet 1125, Internet Service Provider (ISP) 1124, local network 1122 and communication interface 1120. In this way, computer 1101 is able to display the results of the computation to a user in the form of output.

Computer 1101 includes a video memory 1114, main memory 1115 and mass storage 1112, all coupled to bi-directional system bus 1118 along with keyboard 1110, mouse 1111 and processor 1113. As with processor 1113, in various computing environments, main memory 1115 and mass storage 1112, can reside wholly on server 1126 or computer 1101, or they may be distributed between the two. Examples of systems where processor 1113, main memory 1115, and mass storage 1112 are distributed between computer 1101 and server 1126 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1112 may include both fixed and removable media, such as magnetic, optical or magnetic optical storage systems or any other available mass storage technology. Bus 1118 may contain, for example, thirty-two address lines for addressing video memory 1114 or main memory 1115. The system bus 1118 also includes, for example, a 32-bit data bus for transferring data between and among the components, such as processor 1113, main memory 1115, video memory 1114 and mass storage 1112. Alternatively, multiplex data/address lines maybe used instead of separate data and address lines.

In one embodiment of the invention, the processor 1113 is a microprocessor manufactured by Motorola, such as the 680X0 processor or a microprocessor manufactured by Intel, such as the 80X86, or Pentium processor, or a SPARC microprocessor from Sun Microsystems, Inc. However, any other suitable microprocessor or microcomputer maybe utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the cathode raytube (CRT) raster monitor 1117. Video amplifier 1116 is well known in the art and maybe implemented by any suitable apparatus. This circuitry converts pixel data stored in video memory 1114 to a raster signal suitable for use by monitor 1117. Monitor 1117 is a type of monitor suitable for displaying graphic images.

Computer 1101 can send messages and receive data, including program code, through the network(s), network link 1121, and communication interface 1120. In the Internet example, remote server computer 1126 might transmit a requested code for an application program through Internet 1125, ISP 1124, local network 1122 and communication interface 1120. The received code may be executed by processor 1113 as it is received, and/or stored in mass storage 1112, or other non-volatile storage for later execution. In this manner, computer 1100 may obtain application code in the form of a carrier wave. Alternatively, remote server computer 1126 may execute applications using processor 1113, and utilize mass storage 1112, and/or video memory 1115. The results of the execution at server 1126 are then transmitted through Internet 1125, ISP 1124, local network 1122 and communication interface 1120. In this example, computer 1101 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention maybe implemented in any type of computer system or programming or processing environment.

Thus, a cache for active computing environments is described in conjunction with one or more specific embodiments. The invention is defined by the claims and their full scope of equivalents.

1. A method for caching an active computing environment comprising:
obtaining one or more processes in said active computing environment;
determining a state of said active computing environment; and
caching said processes and said state.

2. The method of claim 1 wherein said step of caching further comprises:
relocating said active computing environment to a new location.

3. The method of claim 2 wherein said step of relocating further comprises:
halting said active computing environment.
re-starting said active computing environment in said new location using said state.

4. The method of claim 1 wherein said state comprises an inter-process communication (IPC) state.

5. The method of claim 1 wherein said state comprises a virtual memory state.

6. The method of claim 1 wherein said state comprises a device state.

7. The method of claim 1 wherein said state comprises a file system state.

8. The method of claim 1 wherein said state comprises a central processing unit state.

9. A cache for an active computing environment comprising:
one or more processes;
a state interface configured to determine a state of said one or more processes wherein said state and said one or more processes comprise said active computing environment; and
a cache configured to store said active computing environment.

10. The cache of claim 9 wherein said cache resides in a new location.

11. The cache of claim 10 further comprising:
a halter configured to halt said processes in an old location; and
a re-starter configured to re-start said processes in said new location.

12. The cache of claim 9 wherein said state comprises an inter-process communication (IPC) state.

13. The cache of claim 9 wherein said state comprises a virtual memory state.

14. The cache of claim 9 wherein said state comprises a device state.

15. The cache of claim 9 wherein said state comprises a file system state.

16. The cache of claim 9 wherein said state comprises a central processing unit state.

17. A computer program product comprising:
a computer usable medium having computer readable program code embodied therein configured to cache an active computing environment, said computer program product comprising:
computer readable code configured to cause a computer to obtain one or more processes in said active computing environment;
computer readable code configured to cause a computer to determine a state of said active computing environment;
computer readable code configured to cause a computer to cache said active computing environment.

18. The computer program product of claim 17 wherein said computer readable code configured to cause a computer to cache further comprises:
computer readable code configured to cause a computer to relocate said active computing environment to a new location.

19. The computer program product of claim 18 wherein said computer readable code configured to cause a computer to relocate further comprises:
computer readable code configured to cause a computer to halt said active computing environment;
computer readable code configured to cause a computer to re-start said active computing environment in said new location using said state.

20. The computer program product of claim 17 wherein said state comprises an inter-process communication (IPC) state.

21. The computer program product of claim 17 wherein said state comprises a virtual memory state.

22. The computer program product of claim 17 wherein said state comprises a device state.

23. The computer program product of claim 17 wherein said state comprises a file system state.

24. The computer program product of claim 17 wherein said state comprises a central processing unit state.
